(19) United States
(12) Patent Application Publication
(10) Pub. No.: US 2021/0026013 A1
(43) Pub. Date: Jan. 28, 2021

(54) METHOD FOR CARRYING OUT A MEASUREMENT PROCESS

(71) Applicant: Ibeo Automotive Systems GmbH, Hamburg (DE)

(72) Inventors: Ralf Beuschel, Wangen (DE); Rainer Kiesel, Stetzingen (DE)

(21) Appl. No.: 17/066,704

(22) Filed: Oct. 9, 2020

Related U.S. Application Data
(63) Continuation of application No. PCT/EP2019/058395, filed on Apr. 3, 2019.

(30) Foreign Application Priority Data
Apr. 10, 2018 (DE) 102018205376.6

(51) Int. Cl. G01S 17/10; G01S 7/481; G01S 7/4865; G01S 17/931

(52) U.S. Cl. CPC G01S 17/10; G01S 7/4814; G01S 17/931; G01S 7/4865; G01S 7/4816

(57) ABSTRACT

A method for performing a measurement process for a LIDAR measuring system, wherein during the measurement process a multiplicity of essentially similar measurement cycles are performed, wherein a new measurement cycle only begins after the end of the preceding measurement cycle and a waiting time, wherein the waiting times of consecutive measurement cycles are different.

### CROSS REFERENCE TO RELATED APPLICATIONS

This application is a continuation of International Application No. PCT/EP2019/058395, filed on Apr. 3, 2019, which takes priority from German Patent Application No. 102018205376.6, filed on Apr. 10, 2018, the contents of each of which are incorporated by reference herein.

### FIELD OF THE INVENTION

This disclosure relates to a method for controlling sensor elements of a LIDAR measuring system.

### BACKGROUND

A LIDAR measuring system is described in WO 2017 081 294. This is statically designed and comprises a transmitter unit with a multiplicity of emitter elements and a receiver unit with a multiplicity of sensor elements. The emitter elements and the sensor elements are implemented in a focal plane array configuration and arranged at a focal point of a respective transmitting lens and receiving lens. With regard to the receiver unit and the transmitter unit, a sensor element and a corresponding emitter element are assigned to a specific solid angle. The sensor element is therefore assigned to a specific emitter element.

### SUMMARY

The object of the disclosure is to provide a method in which the detection of highly reflective objects situated outside the defined measurement range is prevented.

This object is achieved by the method according to the current patent claim 1. The dependent patent claims contain descriptions of advantageous embodiments of the method. Such a method is suitable in particular for LIDAR measuring systems that operate according to the TCSPC method (Time Correlated Single Photon Counting). This TCSPC method is explained in more detail in the following text and in particular in the description of the figures. In particular, the method is envisaged for LIDAR measuring systems used in motor vehicles.

A LIDAR measuring system suitable for this purpose comprises sensor elements and emitter elements. An emitter element emits laser light and is implemented, for example, by a VCSEL, Vertical Cavity Surface Emitting Laser. The emitted laser light can be detected by the sensor element, which is formed, for example, by a SPAD, or single photon avalanche diode. The distance of the object from the LIDAR measuring system is determined from the time-of-flight of the laser light or laser pulse.

The emitter elements are preferably implemented on a transmitter chip of a transmitter unit. The sensor elements are preferably implemented on a receiver chip of a receiver unit. The transmitter unit and the receiver unit are assigned to a transmitting lens and a receiving lens respectively. The light emitted by an emitter element is assigned to a solid angle by the transmitting lens. Similarly, a sensor element always observes the same solid angle via the receiving lens. Accordingly, one sensor element is assigned to one emitter element, or both are assigned to the same solid angle.

The emitted laser light always strikes the same sensor element after a reflection in the far field.

The sensor elements and emitter elements are advantageously embodied in a focal plane array configuration, FPA. In such an arrangement the elements of a particular unit are arranged in a plane, for example, the sensor elements on a plane of the sensor chip. This plane is arranged in the focal plane of the respective lens, and/or the elements are arranged at the focal point of the respective lens.

The FPA configuration allows a static design of the LIDAR measuring system and its transmitter unit and receiver unit, so that the system does not comprise any moving parts. In particular, the LIDAR measuring system is arranged statically on a motor vehicle.

An emitter element is conveniently assigned a multiplicity of sensor elements, which together form a macro cell consisting of a plurality of sensor elements. This macro cell, or all sensor elements of the macro cell, are assigned to an emitter element. This allows imaging effects or imaging errors to be compensated, such as the parallax effect or imaging errors due to the lens.

Measurements are carried out on the LIDAR measuring system in order to detect objects and to determine their distance away. A measurement process is performed for each emitter element/sensor element pairing.

A measurement process comprises a multiplicity of measurement cycles. During a measurement cycle, the emitter element emits a laser pulse which can be detected again by one or more sensor elements after reflection at an object. The measurement period is at least sufficiently long that the laser pulse can travel up to the maximum range of the measuring system and back. In such a measurement cycle, for example, different measurement ranges are passed through. For this purpose, for example, sensor elements or sensor groups can be activated and deactivated at different times in order to achieve optimal detection. The measurement cycles of the measurement process do not need to have an identical sequence. In particular, the different times at which sensor elements or sensor groups are activated and deactivated can be subject to a certain time offset from measurement cycle to measurement cycle. The measurement cycles are therefore preferably of a similar nature and therefore not necessarily identical to each other.

A histogram is the result of a measurement process. A measurement cycle has at least the duration required by the laser light to travel back and forth to an object at the maximum measurement distance. The histogram divides the measurement period of a measurement cycle into time segments, also called bins. A bin corresponds to a certain period of time of the entire measurement period.

If a sensor element is triggered by an incoming photon, the bin that corresponds to the associated time of flight, starting from the emission of the laser pulse, is incremented by the value 1. The sensor element or sensor group is read out by a TDC, time to digital converter, and stores the triggering of the sensor element by a photon in the histogram, which is formed, for example, by a memory element or a short-term memory. This detection is added to the histogram in the bin which corresponds to the time of the detection.

The sensor element can only detect a photon, but cannot distinguish whether it originates from a reflected laser pulse or the background radiation. By performing a large number of measurement cycles per measurement process the histogram is filled many times over, wherein the background noise provides a statistically distributed noise baseline but a reflected laser pulse always arrives at the same time. An object thus stands out from the background noise as a peak in the histogram and can thus be evaluated. This is essentially the TCSPC method. An evaluation is carried out by detecting the rising edges or local maxima, for example.

In a measurement process, the measurement cycles can be performed according to a timing scheme which is identical for all successive measurement cycles. In this case, it can happen that a highly reflective object located outside the maximum measurement distance reflects the laser pulse of the previous measurement cycle and this is then detected by a sensor element. As a result, an object that is not within the measurement range may be detected in the subsequent measurement cycle. For example, an object is detected in the near range even though it is actually located at a great distance.

Accordingly, a waiting time is allowed to elapse after each measurement cycle. Alternatively, the waiting time can also be interpreted as a change in the duration of a measurement cycle. This waiting time varies from one measurement cycle to another. As a result, the reflected laser pulse of the distant highly reflective object is detected at a different point in time in the subsequent measurement cycle. Successive waiting times must therefore differ in their duration. This causes the highly reflective object to be smeared in width in the histogram over the measurement cycles. In the evaluation of the histogram, the faraway object is therefore no longer detected.

A first measurement cycle accordingly has a first waiting time, a second measurement cycle having a second waiting time, wherein the first waiting time and the second waiting time are different.

Advantageously, the waiting times of the measurement cycles of the measurement process differ at least to the extent that a highly reflective object is sufficiently smeared in the histogram. For example, the waiting time changes by one bin after each measurement process. For a number of measurements X, the highly reflective object is distributed over X bins at the object and is detected as a kind of increase in the noise background.

In the following, advantageous design variants of the method are explained. It is proposed that the waiting time is within a predefined time segment.

In order to keep the measurement period as short as possible, the waiting time can be defined in advance. Accordingly, the choice of the waiting time may only correspond to a value that lies within the time segment. For example, given a number of measurement cycles X, this time segment can be X bins wide, for example.

In an advantageous embodiment, the waiting time of a measurement cycle is chosen at random.

This allows a statistical component to be introduced. For example, by a linear increase in the waiting time, it is possible that an object may be currently moving at the appropriate speed, thus eliminating the smearing effect. Advantageously, the random selection is combined with a predefined time segment. On the one hand, this allows the statistical component to be combined with a short duration of the measurement process.

Advantageously, a waiting time which has already been used in a measurement process is used up for subsequent measurement cycles.

Each waiting time is thus only present once. In the case of a predetermined time segment, each waiting time is used. However, the time period can also be wider so that there are more waiting segments available than are needed for a measurement. By selecting the appropriate time segment, the entire measurement process and its entire measurement period can be kept as short as possible.

It is further proposed that a waiting period can be available for multiple usage.

If, for example, every waiting time is duplicated, the width of the time interval can be halved. The smearing of the object is still sufficient and the measurement period of the measurement process can be kept to a minimum.

In a further variant, the waiting times are specified deterministically.

For example, this can be a selection of waiting times for a measurement cycle, wherein at least some of the waiting times of different measurement cycles are different from each other, in particular, since the deterministic choice is made in such a way that precisely no ghost objects are detected. These predefined waiting times can be selected, for example, by a modulo counter, which keeps a count of the number of the measurement cycle also and thus selects the corresponding value.

For example, short and long waiting times alternate, wherein the long and short waiting times also differ from each other.

In particular, the waiting times can be repeated multiple times over the entire measurement process, wherein successive waiting times are preferably different. In particular, consecutive waiting times may also be identical, provided that this repetition occurs only a few times.

In the following, the method is explained in detail again using several figures.

### BRIEF DESCRIPTION OF THE DRAWINGS

FIG. 1 shows a LIDAR measuring system in a schematic representation;

FIG. 2 shows a transmitter unit and a receiver unit of the LIDAR measuring system from FIG. 1 in a front view;

FIG. 3 shows a timing chart for a measurement cycle and a corresponding histogram;

FIG. 4 shows a graphical representation of a measurement process with a plurality of measurement cycles;

FIG. 5 shows a graphical representation of another measurement process with a plurality of measurement cycles.

### DETAILED DESCRIPTION OF THE PREFERRED EMBODIMENTS

Hereinafter, specific embodiments of the present solution will be described in detail with reference to the drawings. It should be understood that the specific embodiments described herein are only intended to illustrate the present solution and are not intended to limit the present disclosure

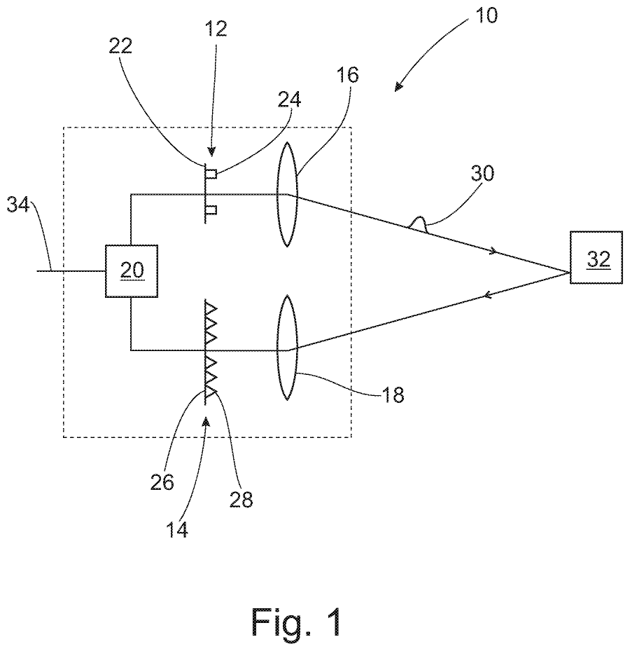

FIG. 1 shows the structure of a LIDAR measuring system 10 in schematic form. Such a measuring system 10 is intended for use on a motor vehicle. In particular, the measuring system 10 is arranged statically on the motor vehicle and, in addition, is conveniently designed statically itself. This means that the measuring system 10, as well as its components and modules, cannot or do not perform any relative movement with respect to each other.

The measuring system 10 comprises a LIDAR transmitter unit 12, a LIDAR receiver unit 14, a transmitting lens 16, a receiving lens 18 and an electronics unit 20.

The transmitter unit 12 forms a transmitter chip 22. This transmitter chip 22 has a multiplicity of emitter elements 24, which for clarity of presentation are shown schematically as squares. On the opposite side the receiver unit 14 is formed by a receiver chip 26. The receiver chip 26 comprises a multiplicity of sensor elements 28. The sensor elements 28 are shown schematically by triangles. However, the actual shape of emitter elements 24 and sensor elements 28 can differ from the schematic representation. The emitter elements 24 are preferably formed by VCSELs, vertical cavity surface-emitting lasers. The sensor elements 28 are preferably formed by SPADs, single photon avalanche diodes.

The transmitter unit 12 and the receiver unit 14 are designed in an FPA configuration, focal plane array. This means that the chip and its associated elements are arranged on a plane, in particular a flat plane. The respective plane is also arranged at the focal point or in the focal plane of an optical element 16, 18. Similarly, the emitter elements 24 are arranged on a plane of the transmitter chip 22 and are located on the measuring system 10 within the focal plane of the transmitting lens 16. The same applies to the sensor elements 28 of the receiver chip 26 with respect to the receiving lens 18.

A transmitting lens 16 is assigned to the transmitter unit 12, and a receiving lens 18 is assigned to the receiver unit 14. A laser light emitted by the emitter element 24 or a light incident on a sensor element 28 passes through the respective optical element 16, 18. The transmitting lens 16 assigns a specific solid angle to each emitter element 24. Likewise, the receiving lens 18 assigns a specific solid angle to each sensor element 28. As FIG. 1 shows a schematic representation, the solid angle in FIG. 1 is not shown correctly. In particular, the distance from the measuring system to the object is many times greater than the dimensions of the measuring system itself.

A laser light emitted by the respective emitter element 24 is always radiated by the transmitting lens 16 into the same solid angle. Due to the receiving lens 18, the sensor elements 28 also always observe the same solid angle. Accordingly, a sensor element 28 is always assigned to the same emitter element 24. In particular, a sensor element 28 and an emitter element 24 observe the same solid angle. In this LIDAR measuring system 10, a multiplicity of sensor elements 28 is assigned to a single emitter element 24. The sensor elements 28 which are assigned to a common emitter element 24 are part of a macro cell 36, the macro cell 36 being assigned to the emitter element 24.

An emitter element 28 emits laser light 30 in the form of a laser pulse 30 at the beginning of a measurement cycle. This laser pulse 30 passes through the transmitting lens 16 and is emitted into the solid angle assigned to the emitter element 24. If an object 32 is located within this solid angle, at least part of the laser light 30 is reflected from it. The reflected laser pulse 30, coming from the corresponding solid angle, is directed through the receiving lens 18 onto the associated sensor element 28 or the sensor elements 28 belonging to a macro cell 36. The sensor elements 28 detect the incident laser pulse 30, wherein a triggering of the sensor elements 28 is read out by a TDC 38, Time to Digital Converter, and written into a histogram. Using the time of flight method, the distance from the object 32 to the measuring system 10 can be determined from the transit time of the laser pulse 30. The objects 32 and their distances are determined advantageously using the TCSPC method, time correlated single photon counting. The TCSPC method is described in more detail in the following.

The sequence of such a measurement cycle is controlled by the electronics 20, which can read out at least the sensor elements 28. The electronics 20 is also connected or can be connected to other electronic components of the motor vehicle via a connection 34, in particular for data exchange. The electronics 20 here is shown as a schematic building block. However, further detailed descriptions of this will not be provided. It should be noted that the electronics 20 can be distributed over a multiplicity of components or assemblies of the measuring system 10. In this case, for example, a part of the electronics 20 is implemented on the receiver unit 14.

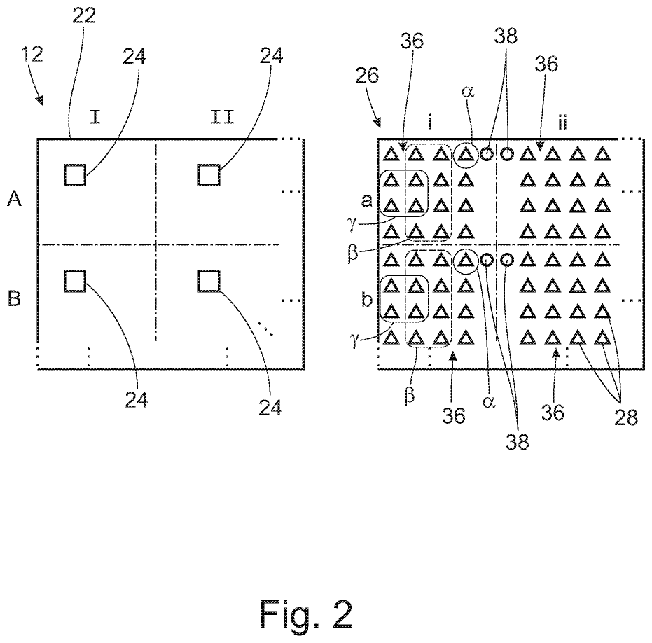

FIG. 2 shows the transmitter chip 22 and the receiver chip 26 schematically in a front view. Only a partial detail is shown, the additional areas being essentially identical to the ones shown. The transmitter chip 22 comprises the emitter elements 24 already described, which are arranged in rows and columns. However, this row and column arrangement is only chosen as an example. The columns are marked with upper case Roman numerals, the rows with upper case Latin letters.

The receiver chip 26 comprises a plurality of sensor elements 28. The number of sensor elements 28 is greater than the number of emitter elements 24. The sensor elements 28 are also implemented in a row and column arrangement. This row and column arrangement is also selected purely as an example. The columns are numbered with lower case Roman numerals, the rows with lower case Latin letters. However, a row or column of the receiver chip 26 does not relate to the individual sensor elements 28, but to a macro cell 36 which has a multiplicity of sensor elements 28. The macro cells 36 are separated from each other by dashed lines for better presentation. The sensor elements 28 of a macro cell 36 are all assigned to a single emitter element 24. For example, the macro cell i, a is assigned to the emitter element I, A. A laser light 30 emitted by a sensor element 24 images at least a part of the sensor elements 28 of the associated macro cell 36.

The sensor elements 28 can advantageously be activated and deactivated individually or at least in groups. As a result, the relevant sensor elements 28 of a macro cell 36 can be activated and the irrelevant ones can be deactivated. This enables the compensation of imaging errors. Such imaging errors can be, for example, static errors, such as imaging errors of the optical elements 16, 18 or else parallax errors, an example of which is explained in the following section.

Due to the parallax, a laser light 30 emitted in the near range, for example, i.e. at a small distance from the object 32, is imaged onto the sensor elements 28 of the macro cell 36 arranged at the top of FIG. 2. However, if the object is further away from the measuring system 10, the reflected laser light 30 will strike a lower region of the macro cell 36 and hence the lower sensor elements 28. The displacement of the incident laser light due to the parallax depends in particular on the arrangement of the units and the physical design of the measuring system 10.

The sensor elements 28 of a macro cell 36 are therefore activated and deactivated during a measurement cycle, so that unilluminated sensor elements are deactivated. Since each active sensor element detects the ambient radiation as background noise, disabling the unilluminated sensor elements keeps the background noise of a measurement to a minimum. As an example, three sensor groups are drawn on the receiver chip 26 in FIG. 2.

By way of example, the sensor groups α, β and γ are shown here, which are intended solely to explain the method. In principle, the sensor groups can also be chosen differently. The sensor group α comprises a single sensor element 28, with which a near range is to be detected at the beginning of the measurement cycle. The sensor group β comprises a multiplicity of sensor elements 28 which are active at a medium measurement distance. The sensor group γ comprises several sensor elements 28 which are active in a far range. The number of sensor elements 28 of the sensor group β is the largest, followed by the sensor group γ.

The selection of the sensor elements 28 for the sensor groups α, β and γ is chosen purely as an example, and in an application case it can also differ from the ones shown, as can the design of the sensor elements 28 and the arrangement in relation to the emitter elements 24.

In the near-range, only a small number of sensor elements 28 is normally active. For example, these sensor elements 28 can also differ in design from the other sensor elements 28 to address specific requirements for the near-range.

The sensor group γ is a partial section from the sensor group β, but also comprises two sensor elements 28 which are exclusive to the sensor group γ. For example, the different sensor groups can also overlap completely, i.e. have a number of common sensor elements 28. However, all sensor elements 28 can also be exclusively assigned to this sensor group. It may also be the case that only a portion of the sensor elements 28 is exclusive to one sensor group, the remaining sensor elements 28 being part of more than one sensor group.

At a transition from a first measurement range to a second measurement range, for example from the medium range to the far range, only some of the sensor elements of the previously active sensor group are then deactivated, wherein some of the sensor elements remain activated and a further number of sensor elements 28 may be activated.

The sensor elements 28 are connected to a TDC 38, time to digital converter. This TDC 38 is part of the electronics 20. A TDC 38 is implemented on the receiving unit for each macro cell 36 and is connected to all sensor elements 28 of the macro cell 36. However, this embodiment for the TDC 38 is only an example.

A sensor element 28 implemented as a SPAD, which is simultaneously active, can be triggered by an incident photon. This triggering is read out by the TDC 38. The TDC 38 then enters this detection into a histogram of the measurement process. This histogram is explained in more detail in the following. After a detection, the required bias voltage must first be re-established on the SPAD. Within this period, the SPAD is blind and cannot be triggered by incident photons. This time required for charging is also known as dead time. It should also be noted in this context that an inactive SPAD takes a certain amount of time to build up the operating voltage.

The emitter elements 24 of the measuring system 10 emit their light pulses sequentially, for example line by line or row by row. This prevents a row or column of emitter elements 24 from triggering the sensor elements 28 of the adjacent row or column of macro cells 36. In particular, the only sensor elements 28 of the macro cells 36 that are active are those for which the corresponding emitter elements 24 have emitted a laser light 30.

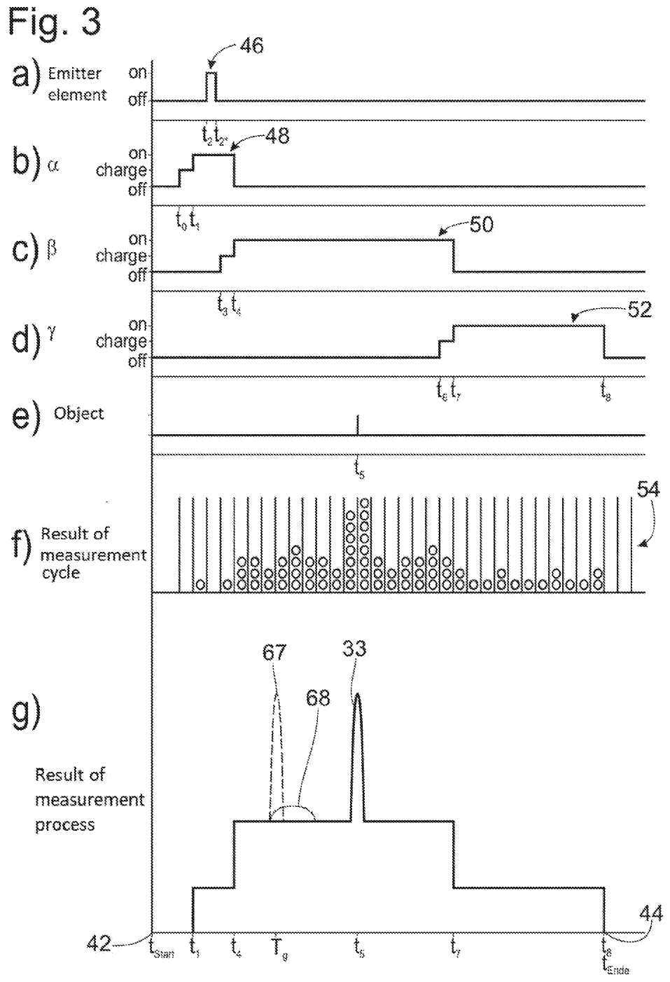

As mentioned earlier, the TCSPC method is provided for determining the distance of the objects. This is explained based on FIG. 3. In the TCSPC, a measurement process is performed to determine any objects present and their distance from the measuring system 10. A measurement process comprises multiple essentially similar measurement cycles, which are repeated identically to produce a histogram.

This histogram is then evaluated to identify any objects and their distances. FIG. 3 comprises a number of sub-figures a, b, c, d, e, f, g. Each of the figures has its own Y-axis, but shares a common X-axis on which time is plotted. FIGS. 3a to 3f show a single measurement cycle, wherein FIG. 3g shows the result of an entire measurement process. A measurement process starts at time tₛₜₐᵣₜ and ends at time t_{ende}.

FIG. 3a shows the activity of an emitter element 46 over the course of a measurement cycle. The emitter element is activated at the time t₂ and deactivated shortly afterwards at the time t_{2*}, causing a laser pulse to be emitted.

Figures b, c and d show the activity phases of the sensor elements 28 of the sensor groups α, β and γ within a measurement cycle. The sensor element of the sensor group α is already charged before the emission of the laser pulse at time t₀ and is already active at time t₁. The times t₁ and t₂ can temporally coincide or be offset relative to each other. The sensor group α is therefore active at the latest when the laser pulse 30 is emitted. This corresponds to the near range.

The sensor elements of the sensor group β are charged shortly before the sensor group α is deactivated at time t₃ and are active at the time t₄, when the sensor group α is deactivated. The sensor group β, which covers the medium range, remains active for a longer period of time until it is switched off at the transition to the far range.

The activity of the sensor elements 28 of the sensor group γ is shown in FIG. 3d. Since the sensor group γ is partly a subgroup of β, the overlapping sensor elements 28 are left active at time t₇, whereas the other sensor elements 28 of the sensor group β are deactivated. The remaining sensor elements 28 of the sensor group γ are already charged in advance at time t₆. The sensor group γ also remains active for a longer period of time until it is deactivated at time t₈. The time t₈ also corresponds to the end of the measurement cycle at time t_{ende}. However, in other exemplary embodiments, the end of the measurement cycle does not need to be exactly the same as the deactivation of the last active sensor group. The beginning of the measurement cycle 42 is defined by the time tₛₜₐᵣₜ and the end of the measurement cycle 44 is defined by the time t_{ende}.

The measurement cycle thus includes the emission of the laser pulse 46, the switching between the sensor groups and the detection of incident light in the near range 48, in the medium range 50 and in the far range 52.

FIG. 3e shows an example of an object 32, which is situated in the medium range. The graph corresponds to the reflection surface of the object 32. The laser pulse 30 reflected at the object 32 can be detected by the active sensor elements 28 of the sensor group β at time t₅.

FIG. 3f shows a histogram 54, which represents an exemplary filling of a plurality of measurement cycles. The histogram divides the whole of the measurement cycle into individual time segments. Such a time interval of a histogram 54 is also called a bin 56. The TDC 38, which populates the histogram 54, reads out the sensor elements 28. Only an active sensor element 28 can transmit a detection to the TDC 38. If a SPAR is triggered by a photon, the TDC 38 enters a digital 1 or a detection 58 in the histogram, which is represented by a memory, for example. The TDC associates this detection 58 with the current time and fills the corresponding bin 56 of the histogram 54 with the digital value.

Since there is only a single object 32 in the medium range, only this one object 32 can be detected. Nevertheless, the histogram is filled with detections 58 over the entire measurement cycle. These detections 58 are generated by the background radiation. The photons of the background rays can trigger the SPADs. The level of the resulting background noise is therefore dependent on the number of active SPADs, i.e. the number of sensor elements 28 of a sensor group.

It can be seen that in the near range 48 only two bins 56 are filled with one detection 58 each, while a third bin remains empty. This corresponds to the detected background radiation. The number of detections is very small, as only a single SPAD is active.

In the medium range 50 that follows it, the sensor group β is active, which has a plurality of active sensor elements 28. Accordingly, the detected background radiation is also larger, so that a bin is filled on average with three detections 58, sometimes also 4 or 2 detections 58. In the region 32, in which the reflecting surface of the object 32 is located at time t₅ of the measurement cycle, the number of detections 58 is significantly higher. In this case, seven or eight 58 detections are recorded in the histogram 54.

There is no object that can be detected in the far range 52. Here, only the background radiation is represented with an average of one to two detections 58 per bin. The mean value of the noise background is therefore lower than in the medium range 50, as the number of SPADS is also lower. However, the mean value of the detections 58 is higher than in the near range 48, since the near range 48 with the sensor group α only shows a fraction of the number of sensor elements 28 of the sensor group γ.

As mentioned above, the histogram shown is filled in an exemplary way only. The number of bins and their filling level can differ significantly in an actual measurement cycle. Normally, no object 32 can yet be detected from a single measurement cycle. Therefore, with the TCSPC method a plurality of measurement cycles are carried out in succession. Each measurement cycle populates the same histogram. Such a histogram, which has been filled by a plurality of measurement cycles, is shown in FIG. 3g.

The histogram of FIG. 3g is also formed by digitally filled bins. To provide a clearer picture, however, the representation of each bin has been omitted in this figure and replaced by a single line that corresponds to the filling level of the bins.

A low noise background is obtained in the near range 48, and the highest noise background is obtained in the medium range 50, since it is here that the most sensor elements are also active. In the far range 52, the noise background determined is between that of the near range 48 and that of the far range 50. In addition, the detection of the laser light 30 reflected by the object 32 in the medium range 50 can be seen in the form of a peak 33. The detected background radiation is statistically uniformly distributed, thus providing an essentially straight line depending on the number of active sensor elements. However, the object and its reflecting surface are always at the same place and over the sum of the measurement cycles the peak 33 stands out over the background noise level.

The peak 33 can now be detected via its maximum or its steeply rising edge as object 32 and the distance to the object 32 can be determined from its position in the histogram.

In the determination of the histogram according to FIG. 3g, the measurement cycle of FIG. 3 was repeated identically many times over. In particular, all described actions are always performed at the same times t₀ to t₈.

To improve detection, the measurement cycles can also be designed to be merely similar in nature, instead of identical. To do this, the activation and deactivation of the sensor groups is time-shifted slightly from measurement cycle to measurement cycle. This allows the steeply rising and falling edges to be flattened at the junctions between the measurement ranges. For further explanations, however, the use of FIG. 3g is more than adequate.

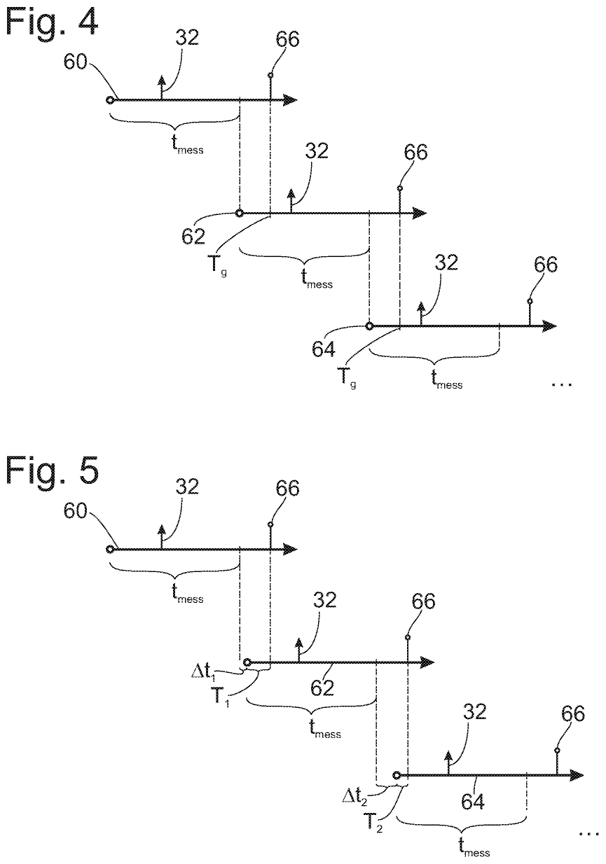

FIG. 4 shows a measurement process comprising multiple measurement cycles 60, 62 and 64. With regard to the first measurement cycle 60, the second measurement cycle 62 and the third measurement cycle 64, the respective time axis is drawn, which extends beyond the measurement period tₘₑₛₛ of a measurement cycle.

The measurement period tₘₑₛₛ includes the object 32, which is detected by the sensor element 28 at the time shown. It is this object 32 that generates the peak 33 in the histogram according to FIG. 3f.

In addition, an object 66 is shown. This object 66 is located outside the defined maximum measurement range of the LIDAR measuring system 10. Furthermore, the object has a reflectivity, which causes a detection by a sensor element 28 in a subsequent measurement cycle. The laser pulse 30, which was emitted at the beginning of the first measurement cycle 60 and reflected at the object 66, is now detected in the second measurement cycle 62. The detection in the second measurement cycle occurs at the time T_{g}.

For the sake of simplicity, the object does not move relative to the LIDAR measuring system over the measurement period of the measurement process. In addition, the next measurement cycle in the measurement process is started immediately at the end of a measurement cycle. The laser pulse of the second measurement cycle 62 in the third measurement cycle 64 is thus also detected at time T_{g}.

A peak 67 is formed in the histogram. This peak 67 is detected as a ghost object at a short distance, although the object 66 is actually located outside of the maximum measurement range.

Such a ghost object can be ignored by the method explained by reference to FIG. 5.

FIG. 5 also shows three measurement cycles 60, 62 and 64 of a plurality of measurement cycles of a measurement process. Objects 32 and 66 behave identically to the method explained in FIG. 4.

A first waiting time Δt₁ is allowed to elapse between the end of the first measurement cycle 60 and the beginning of the second measurement cycle 62. As a result the laser pulse reflected at the object 66 is detected at time T₁. A second waiting time Δt₂ is allowed to elapse between the end of the second measurement cycle 62 and the beginning of the third measurement cycle 64. The first waiting time Δt₁ and the second waiting time Δt₂ are different. As a result the laser light which is reflected at the object 66 is detected at time T₂. Other waiting times also differ from one another in the same way.

The peak 67 is thus smeared into the smeared peak 68. When the histogram is evaluated, no ghost object is now detected.

The waiting times can increase linearly, i.e. can be extended by a certain value from measurement cycle to measurement cycle. Here, however, an object outside the maximum measurement range may perform a movement that cancels out the change in the waiting time.

It is therefore proposed that the duration of the waiting time is randomly selected from measurement cycle to measurement cycle. The probability that an object is currently performing such a relative movement with respect to the measuring system is almost zero. Nevertheless, in order to keep the measurement period of the measurement process short, a time range can be specified in which the waiting times are included. Such a time range advantageously comprises a plurality of bins.

In order to achieve uniform smearing, a waiting time that has already been used may also be used again for subsequent measurement cycles. This ensures that each waiting time in the time range is used only once or with a limited frequency. In addition, the time range can be selected smaller than the number of measurement cycles multiplied by the duration of a bin. In particular, this makes it possible to define very precisely the shape into which a peak of a ghost object is smeared.

As an alternative to the random selection of the waiting time, a deterministic selection of the waiting times can also be used. In this case the waiting times are already defined in advance and are used for the consecutive measurement cycles. The deterministic choice provides the waiting times in such a way that no ghost objects are detected. For example, the waiting times are also selected within a time range, wherein the waiting times are a minimum distance apart from each other. In particular, long and short waiting times are chosen alternately.

A minimum distance is also possible for the statistical distribution in order to distribute the detections of the distant object optimally in the histogram.

In principle, the comments on the statistical choice of the waiting times are applicable mutatis mutandis to the deterministic choice of the waiting times, and vice versa.

A time control unit is implemented on the electronics 20 on the measuring system for carrying out this method. This electronics controls the timing sequence of the measurement process, in particular the individual measurement cycles, and the timed activation and deactivation of the individual elements of the measuring system. For example, this time control unit has a timing controller. Accordingly, the time control unit controls the exact observance of the waiting times between the measurement cycles.

The above examples are only preferred examples of the present invention and are not intended to limit the present invention. Any modification, equivalent replacement, improvement, etc. made within the spirit and principle of the present invention should be included within the protection scope of the present solution.

The preferred embodiments of the present invention have been described in detail with reference to the accompanying drawings. However, the present invention is not limited to the specific details in the above embodiments. Within the scope of the technical concept of the present invention, the technical schemes of the present invention can be subjected to simple modifications, and these simple modifications all belong to the protection scope of the present invention.

Further to be noted that, in various specific features of the above-described specific embodiments described, may be combined in any suitable manner without conflict. To avoid unnecessary repetition, the present invention will not further descript the various possible combinations.

Further, among various embodiments of the present invention may be arbitrarily combined as long as it does not violate the spirit of the invention, which should also be considered as the disclosure of the present invention.

1. A method for performing a measurement process for a LIDAR measuring system (10),
wherein during the measurement process a multiplicity of essentially similar measurement cycles are carried out,
wherein a new measurement cycle only begins after the end of the preceding measurement cycle and a waiting time,
wherein the waiting times of consecutive measurement cycles are different.

2. The method according to claim 1, wherein the waiting time lies within a predefined time segment.

3. The method according to claim 1, wherein the waiting time of a measurement cycle is selected randomly.

4. The method according to claim 1, wherein a waiting time which has already been used in a measurement process is used up for subsequent measurement cycles.

5. The method according to claim 4, wherein a waiting time is available for multiple use.

6. The method according to claim 1, wherein the waiting time of a measurement cycle is selected deterministically.
